(19) United States
(12) Patent Application Publication
(10) Pub. No.: US 2002/0083177 A1
(43) Pub. Date: Jun. 27, 2002

(54) Communications unit, a server for a communications unit, and a method for controlling performance features in a communications network

(76) Inventor: Jorge-Alberto Perez Ramirez, Witten (DE)

Correspondence Address: BELL, BOYD & LLOYD, LLC, P. O. BOX 1135, CHICAGO, IL, 60690-1135, US

(21) Appl. No.: 09/898,628

(22) Filed: Jul. 3, 2001

(30) Foreign Application Priority Data
Jul. 4, 2000 (DE) 100 32 416.9

(51) Int. Cl. G06F 15/173

(52) U.S. Cl. 709/226; 709/223

(57) ABSTRACT

The present invention relates to: (a) a server for a preferably private communications network having a number of communications units which are networked to one another, and having a first controller for centrally controlling performance features in the communications network; (b) to a communications unit for use with this server; and (c) a method for controlling performance features in a preferably private communications network.

### BACKGROUND OF THE INVENTION

1. Field of the Invention

The present invention relates to the availability of performance features for a communications network wherein a server and a number of communications units are connected thereto.

2. Description of the Prior Art

In private communications networks, communications units are being increasingly networked to one another via computer networks (for example, an LAN (Local Area Network)) in which case the transmission of data in the communications network is implemented using the known IP protocol (Internet Protocol). The users of the communications network are generally provided here with network-wide performance features; for example, parking and transfer of a parked connection, abbreviated dialing, etc.

Sequence control of the performance features is generally carried out locally by one of the communications units. The performance features are implemented and activated here by, for example, transmitting messages using a communications unit-specific protocol. Moreover, performance features can be implemented between the individual communications units by setting up virtual ports in the communications units using what is referred to as a DISA (Direct Inward System Access) functionality in which a subscriber can activate performance features of the communications unit from outside the private communications network via DISA-specific messages.

A disadvantage of this solution is that resources, such as storage space and processor power, are taken up in the network nodes (communications units) involved during the activation of network-wide performance features in a private communications network. Because only a restricted number of performance features are defined in the IP protocol, the solution described also provides only a restricted level of availability of performance features in comparison with a private communications network with just one communications unit in which a multiplicity of performance features are defined via communications unit-specific protocols.

An object of the present invention is, thus, to provide an apparatus and a method which permit savings in terms of resources in the individual communications units together with expanded functionality of network-wide performance features in a computer network.

### SUMMARY OF THE INVENTION

According to the present invention, therefore, a server is used to control and activate network-wide performance features. According to the present invention, the server assumes here the function of controlling the signaling which is necessary to implement selected network-wide performance features overlapping between the communications units.

The communications unit according to the present invention, also referred to in the literature in this context as “client,” implements, performance features locally or with other communications units in the communications network together with the server using a suitable communication protocol.

The centralization of control of performance features according to the present invention in a private communications network, i.e., the exporting of functions to a server, results in numerous advantages.

First, in order to implement the performance features in the individual communications units, fewer resources, for example storage space and processor power, have to be provided locally.

Furthermore, new performance features can be implemented more easily and more quickly because the performance features for the entire communications network are essentially implemented in the server.

In addition, performance features which are not provided by networking protocols (for example, the IP protocol) according to the prior art can now be utilized by a larger number of users (subscribers). This results in an expansion of the scope of performance features in a private communications network having a number of communications units which are networked to one another. The corresponding performance feature is provided not only at an individual communications unit but also on a network-wide basis via the server via appropriate communications mechanisms.

In order to control performance features, signaling messages are generated and evaluated between the server and one or more communications units. The signaling messages contain here, for example, information relating to the type of performance feature to be activated and/or to data which have to be stored in conjunction with this performance feature. These functions are carried out here by a first controller in the server and/or by a second controller in the communications unit according to the present invention. The signaling messages are transmitted via the first interface by the server and/or via the second interface by the communications unit.

The server has in addition a storage device for permanently and/or temporarily storing data which are required to execute the respective performance feature. Such data are, for example, telephone numbers for the known “abbreviated dialing” performance feature (permanent) or data relating to a connection for the known “Holding” performance feature (temporary).

In one embodiment of the present invention, the server or the first controller of the server executes performance features which relate to just one communications unit, for example the “abbreviated dialing” performance feature in which a subscriber establishes a connection to a further subscriber via abbreviated dialing.

In a further embodiment of the present invention, the server or the first controller of the server executes performance features which relate to a number of communications units. For example, as in the case of the “Holding” and “Acceptance” performance features in which a subscriber which is connected to a communications unit parks a connection in the system and another subscriber which is connected to a further communications unit accepts this call.

The individual communications units are advantageously networked to one another, and the communications units are advantageously networked to the server via a local network (LAN, Local Area Network), the data being transmitted via the local network via the IP protocol. The server is connected to the network here via the first interface, and the communications units are each connected to the network via a second interface.

Additional features and advantages of the present invention are described in, and will be apparent from, the Detailed Description of the Preferred Embodiments and the Drawings.

### DESCRIPTION OF THE DRAWINGS

FIG. 1 shows a schematic view of the inventive server and of an inventive communications unit in a private communications network;

FIG. 2 shows a private communications network with a server in accordance to the teachings of the present invention;

FIG. 3 shows the NLM server/client concept to which the present invention may be directed;

FIGS. 4 and 5 show a schematic diagram relating to the implementation of the functionality of the network-wide performance features of the present invention; and

FIG. 6 shows a schematic diagram relating to storage-related performance features of the present invention.

### DETAILED DESCRIPTION OF THE PREFERRED EMBODIMENTS

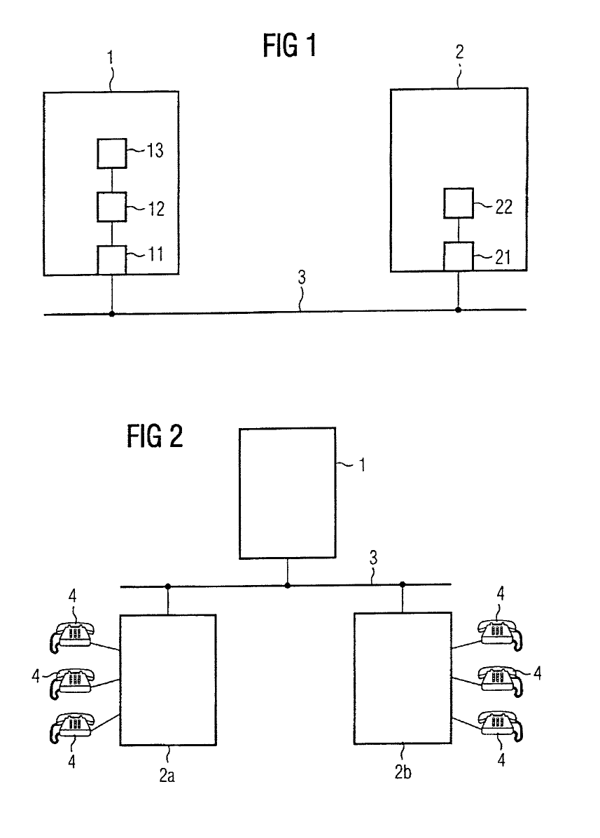

FIG. 1 shows a schematic view of a server 1 according to the present invention which is connected to a multiplicity of communications units via a local network 3. A communications unit 2 according to the present invention is illustrated by way of example.

The server 1 of the present invention has a first interface 11 for connecting to the local network 3 (LAN). Furthermore, the server 1 has an inventive first controller 12 for centrally controlling and implementing performance features in the local network 3, and a storage device 13 for centrally storing data.

The communications unit 2 of the present invention has a second interface 21 for connecting to the local network 3, and an inventive second controller 22 for controlling and implementing performance features in cooperation with the server 1.

The first and second controllers 12 and 22 according to the present invention are advantageously configured here as program-controlled controllers so that control is carried out via software which is implemented in the server 1 or in the communications unit 2.

FIG. 2 shows a preferably private communications network with a server 1 according to the present invention, and two inventive communications units 2a and 2b, the server 1 and the communications units 2a, 2b being connected to one another via a local network 3. The components of the server 1 which are configured so as to control the performance features are referred to below as an NLM server 1, and the components of the communications unit 2a, 2b which are configured so as to control the performance features are referred to below as an NLM client 2a, 2b, NLM being a designation for network-wide performance feature.

The communications units 2a, 2b are each connected to the local network 3 via a network-specific subscriber line module which provides the second interface 21. The communications units 2a, 2b each include software for controlling the communications unit 2a, 2b and, in addition, software for controlling the respective NLM clients 2a, 2b, and a local database for storing permanent or temporary data. Analog and/or digital (ISDN) terminals 4, for example, telephones or data processing devices (for example a personal computer PC), can be connected to the communications units 2a, 2b.

For example, CTI (Computer Telephony Integration) and administration applications, such as voice recognition applications, are integrated on the NLM server 1. Furthermore, the NLM server 1 makes available a network-wide database.

As described at the beginning, performance features can continue to be implemented between the individual communications units 2a, 2b in accordance with the prior art; for example, by transmitting communications unit-specific signaling messages via a communications network. In addition, however, according to the present invention it is also possible to implement performance features via what is referred to as an NLM server/client concept.

With the concept according to the present invention for implementing performance features it is possible both to implement standard performance features (for example, the “parking” performance feature) and access a central database or a central storage device via the NLM server 1 in order to store memory-intensive information outside the NLM clients 2a, 2b at a central location (for example, abbreviated dialing, project-specific codes, telephone lists, etc.).

Likewise, it is possible to implement on the NLM server 1 a functionality which corresponds to the DISA functionality already described. Furthermore, new DISA performance features can be implemented.

By virtue of the server/client concept according to the present invention for implementing performance features, novel performance features which are not supported by the protocols used hitherto are conceivable by virtue of the integration of the communications unit and the PC.

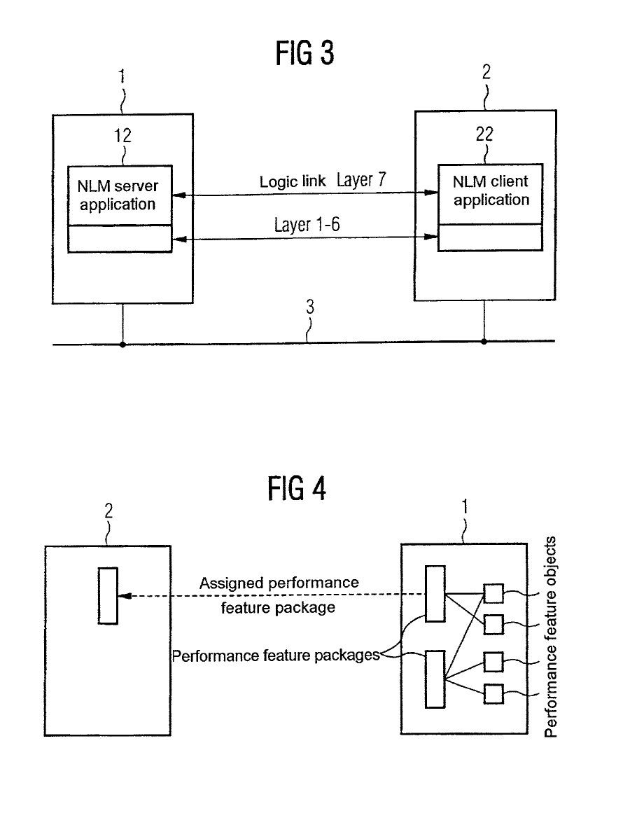

The NLM server/client concept according to the present invention will be explained in more detail with reference to FIG. 3.

In order to implement this concept, components which communicate with one another are required between the NLM server 1 and the NLM clients 2a, 2b. By way of example, an NLM server application, the first controller 12, is illustrated on the NLM server 1, and on the other hand an NLM client application, the second controller 22, is illustrated on the NLM clients 2a, 2b. A logic connection, frequently referred to in the literature as a “link,” is implemented between the two components here via a component-specific protocol.

In order to implement the functionality of the network-wide performance features, the NLM server application provides each of the NLM clients 2a, 2b with a specific quantity of performance feature objects, each performance feature object corresponding to a performance feature, as shown below in FIG. 4.

Each performance feature object is assigned here specific features; for example, “Range” of the performance feature (only local or network-wide), “timed implementation capability of a performance feature” (only for the current connection or for all connections), etc. These features can be configured individually and are used to implement the respective performance feature on the respective NLM clients 2a, 2b.

After the rules have been defined, coherent performance feature objects are combined in what are referred to as performance feature packages. These performance feature packages are made available to the respective NLM clients 2a, 2b by the NLM server 1 so that the respective NLM client 2a, 2b knows which performance features it can/is allowed to implement and to what extent it can/is allowed to do so. So that the respective NLM client 2a, 2b can access the NLM server 1, the IP address of the NLM server 1 and the port address of the NLM server application must be known to the NLM clients 2a, 2b.

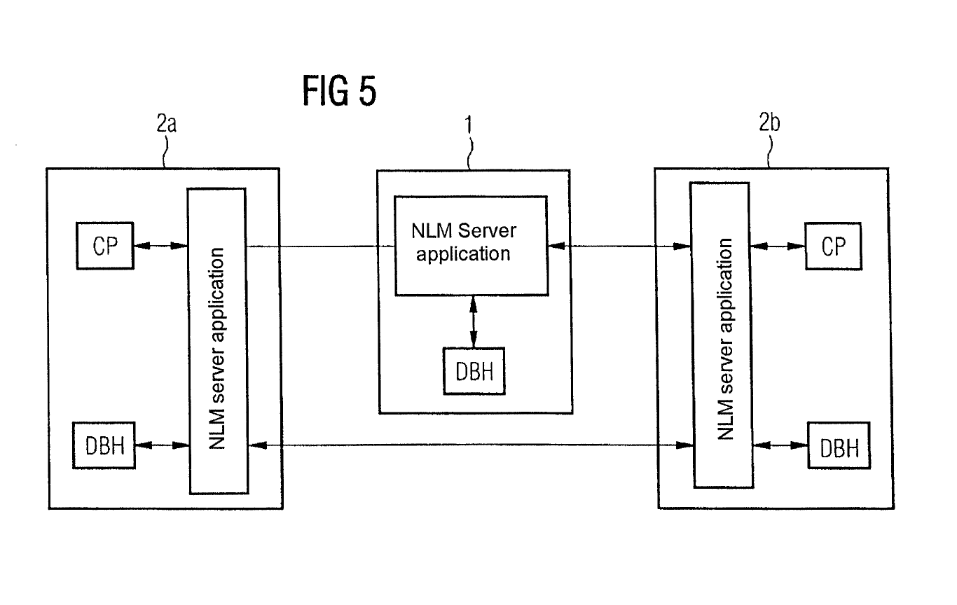

The implementation of performance features will be explained in more detail below with reference to FIG. 5, the individual functional units of the NLM server 1 and of the NLM clients 2a, 2b which are required to implement performance features being shown.

What is referred to as “Call Processing” CP is a client-internal software interface which is required for activating and implementing an NLM performance feature. The NLM client application of the respective NLM client 2a, 2b converts the signaling of the call processing CP into corresponding NLM messages (signaling messages) and transmits them to the NLM server 1 via corresponding communications mechanisms that are based on the IP protocol.

The NLM server 1 evaluates the received NLM messages and initiates appropriate actions; for example, reserves performance feature objects, transmits further signaling messages to other NLM clients 2a, 2b, etc. In cases in which a further NLM client 2a, 2b is involved in the implementation of a performance feature, the NLM client 2a, 2b obtains corresponding signaling messages for activating performance features, usually via the NLM server 1. The respective NLM client application then correspondingly signals this to the associated Call Processing CP of the NLM client 2a, 2b.

Both the NLM client application and the NLM server application each have interfaces (DBH, Database Handler) to a local or central database.

The signaling messages can be exchanged here as a function of the performance feature to be implemented between an NLM client 2a, 2b and the NLM server 1, or between the NLM clients 2a, 2b without the participation of the NLM server 1.

When performance features are implemented, two types of signaling messages are distinguished; signaling messages for activating/enabling performance feature objects and signaling messages for communication.

Regarding signaling messages for activating/enabling performance feature objects, a network-wide performance feature is activated by an NLM client 2a, 2b. The NLM client 2a, 2b transmits a corresponding signaling message with the performance feature information to the NLM server 1. By activating the performance feature, a performance feature object is reserved in the NLM server 1 and the NLM client 2a, 2b is assigned to what is referred to as the “owner” of the performance feature object. Only the “owner” (i.e., the respective NLM client) can enable again or terminate a performance feature object.

On the other hand, the signaling messages for communication are exchanged between a number of NLM clients 2a, 2b or between an NLM client 2a, 2b and the NLM server 1 in order to trigger certain actions or generate acknowledgements. Here, no performance feature objects are reserved or enabled.

A signaling message essentially contains information on the sender (NLM client 2a, 2b, NLM server 1), the receiver (NLM server 2a, 2b, NLM client 1) and information on the respective performance feature object (the information defining, for example, the performance feature to be activated and having supplementary information on this performance feature).

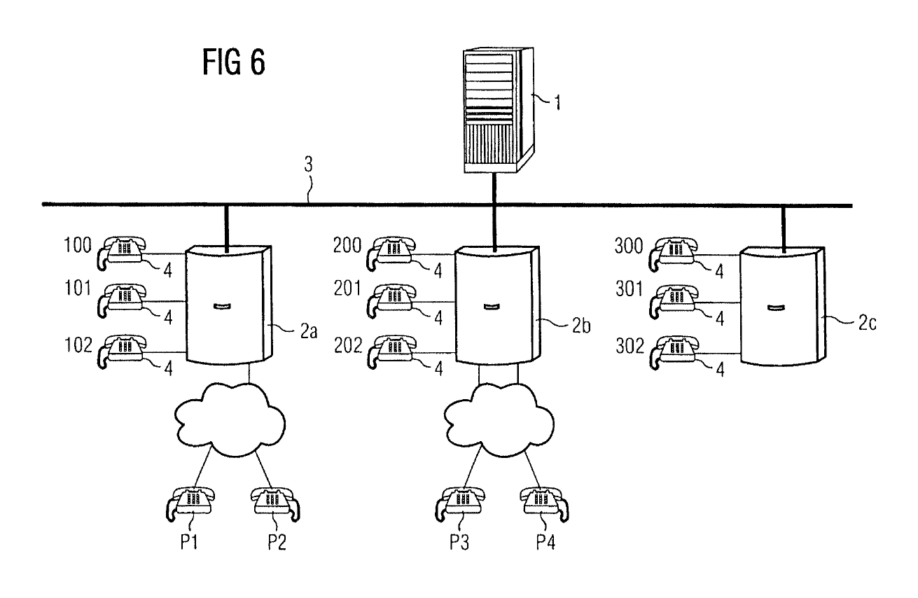

The principle of the present invention will be further clarified via exemplary performance features and with reference to FIG. 6.

As a first example, what are referred to as the “parking” and “Acceptance from parking” performance features will be described below. Usually, a number of calls (for example, a total of 10) can be parked simultaneously in the communications system. In the prior art, a single digit parking code 0 . . . 9 is provided for local parking.

So that the “parking” and “Acceptance from parking” performance features can be made available on a network-wide basis, it is necessary to ensure that the parking code is uniquely defined for network-wide parking. To achieve this, the parking code can either lie outside the range 0 . . . 9, for example, in the range of greater than 10, or the value range for the parking codes can be limited and divided up, for example, 1 . . . 5 for local parking and greater than 5 for network-wide parking.

The associated performance feature object which is reserved in the NLM server 1 has, for example, the following properties:

maximum number of network-wide parking possibilities;

permitted code number range;

“parking” performance feature allowed/not allowed; and

“Acceptance from parking” performance feature allowed/not allowed.

By way of example, a subscriber P1 (external subscriber) is connected to the extension 4 defined by the direct dialing extension number 100. The extension 4 is connected to the communications unit 2a. When the subscriber P1 is parked by the extension 4, a corresponding NLM message is transmitted to the NLM server application of the NLM server 1 by the NLM client application of the communications unit 2a. The “parking” performance feature object with the properties described above is generated in the NLM server 1. The NLM client 2a is the “owner” of the object here. The NLM server application then transmits signaling messages (“parking on”) to the other NLM clients 2a, 2b, the signaling messages containing information on the “owner” of the object and the parking position, i.e., the parking code.

When the subscriber P1 is accepted (“Acceptance from parking” performance feature) by the extension 4 with the direct dialing extension number 200, the NLM client application of the NLM client 2b transmits a signaling message to the NLM client 2a with an indication of the (“acceptance”) performance feature and of the parking position. There is then message traffic between the NLM clients 2a and 2b in order to transfer the subscriber P1 to the extension 200. Furthermore, there is a signaling message from the NLM client 2a to the NLM server 1 in order to enable the corresponding performance feature object in the NLM server 1.

The described variant has the advantage that little signaling traffic (few signaling messages) is generated between the NLM clients 2a, . . . , 2c and the NLM server 1, but there is a higher storage demand at the individual NLM clients 2a, . . . , 2c.

In the alternative variant described below, there is less storage demand at the individual NLM clients 2a, . . . , 2c than in the first variant. Here, in accordance with the example described above, the NLM clients 2b and 2c do not need to store the parking position and the associated NLM client 2a. During removal from parking (“Acceptance from parking”), in contrast to the example described above, a signaling message is transmitted from the NLM client 2b to the NLM server 1 (for signaling the acceptance), and not to the NLM client 2a. Then, the NLM server 1 transmits a signaling message (for signaling the acceptance) to the NLM client 2a. The rest of the sequence remains as described above. However, in this method, the signaling volume between the respective NLM clients 2a, . . . , 2c and the NLM server 1 is higher than in the first variant. On the other hand, the necessary data are stored centrally in the NLM server 1 so that there is a smaller storage demand at the respective NLM clients 2a, . . . , 2c. The parking code is then checked completely by the NLM server 1.

As a further example of network-wide performance features, storage-related performance features will be described below, again with reference to FIG. 6.

In the case of storage-related performance features, data are read from the NLM server 1 into the respective NLM client 2a, . . . , 2c according to requirements. As a result of this, the storage loading of the individual NLM clients 2a, . . . , 2c, can be reduced by storing and handling data centrally (at the NLM server 1). In addition to this exporting of functions and memory access operations, access operations to new data in order to implement new performance features are also conceivable using these mechanisms.

These mechanisms can be processed only if the corresponding performance feature object is permitted. In the case of a network-wide performance feature which is not permitted, the performance feature is processed locally on the respective NLM client 2a, . . . 2, c, as in the prior art.

As an example of this, the “project-related code number” performance feature (PKZ) will be described below. The associated performance feature object which is reserved in the NLM server 1 has, for example, the following property: access to the corresponding performance feature (in the example PKZ) permitted/not permitted. When access is permitted, the code numbers for this performance feature are read out of the NLM server 1. When it is not permitted, the code number is read out of the respective NLM client 2a, . . . , 2c.

If, for example, the subscriber on the extension 4 with the direct dialing extension number 100 has to enter a project-related code number in order to be able to establish a connection to a public communications network, list checking takes place. Here, after the corresponding project-related code number has been entered, a signaling message is transmitted from the corresponding NLM client 2a to the NLM server 1. Checking for correctness is carried out in the NLM server 1, for which process it is not necessary to reserve a performance feature object. Then, there is a signaling message from the NLM server 1 to the NLM client 2a to determine whether the project-related code number which has been entered corresponds to a project-related code number stored in the NLM server 1. If it does correspond, the direct dialing of the extension is permitted.

Further storage-related performance features via the NLM server 1, such as central abbreviated dialing, recorded messages in the absence of the called party, recorded information, etc., are conceivable using similar mechanisms.

Furthermore, it is possible to implement a DISA functionality. The following performance features are examples of the DISA functionalities: night service, follow me, code lock, incoming call protection, call forwarding, etc.

Via the performance feature DISA (Direct Inward System Access), it has been possible in the prior art to activate performance features, for example call forwarding, in a communications unit via an external connection. Furthermore, it has been possible to set up an outgoing external connection via the incoming external connection using the DISA performance feature.

The NLM server/client concept can be used to implement a DISA-like functionality with the following feature: if network-wide DISA functions are not activated, local DISA functions continue to be possible on the individual NLM clients 2a, . . . , 2c. The network-wide DISA can be activated only if the associated performance feature packet is activated in the NLM server 1. If this packet is activated, access to the local DISA functions is barred.

In the network-wide DISA, only the activation and/or deactivation of the performance feature and writing into the database are implemented in the NLM client 2a, . . . , 2c. The further logic, for example, access protection, authorization checking, assignment, variants, is implemented at the NLM server 1.

The advantage of the network-wide DISA functions is that the user no longer needs to remember a DISA call number of the respective NLM client 2a, . . . , 2c; he/she simply enters the respective subscriber number directly. The assignment to the respective destination is performed by the NLM server 1; the necessity to set up a DISA call number per NLM client 2a, . . . , 2c is thus eliminated.

In a further step it is conceivable to control the DISA functions via a PC at a workstation. This PC is connected to the local network 3 and would exchange corresponding signaling messages with the NLM server 1. In this way, the user would be provided with a convenient user interface for implementing these performance features.

Further, new network-wide performance features, for example the “appointments facility” performance feature, in which a subscriber has the possibility of programming an appointment and an appointment call is made when the time for this appointment arrives, are conceivable by virtue of the NLM server/client concept of the present invention. The appointment functionality is integrated in the NLM server 1 here in that, for example, an appointment is transferred into the NLM server 1 and when the time for this appointment arrives this is signaled to the respective terminal 4 by the NLM server 1. It is, therefore, possible to generate a number of appointments with new features (once, cyclical, etc.). The processing and activation of the performance features between the NLM server 1 and the respective NLM client 2a, . . . , 2c is carried out in a corresponding manner, as already described.

Although the present invention has been described with reference to specific embodiments, those of skill in the art will recognize that changes may be made thereto without department from the spirit and scope of the invention as set forth in the hereafter appended claims.

I claim as my invention:

1. A server for a communications network having a plurality of communications units which are networked to one another, the server comprising:
a first interface for connecting the server to the communications network; and
a first controller for centrally controlling network-wide performance features in the communications network.

2. A server for a communications network as claimed in claim 1, wherein signaling messages are at least one of generated and evaluated by the first controller in order to control the performance features, the signaling messages being transmitted between the transmitted between the server and at least one of the plurality of communications units.

3. A server for a communications network as claimed in claim 2, wherein the first interface transmits the signaling messages between the server and at least one communications unit.

4. A server for a communications network as claimed in claim 1, further comprising:
a storage device for centrally storing performance feature-specific data.

5. A server for a communications network as claimed in claim 1, wherein the first controller controls performance features associated with an individual communications unit.

6. A server for a communications network as claimed in claim 1, wherein the first controller controls performance features associated with a plurality of communications units simultaneously.

7. A server for a communications network as claimed in claim 1, wherein the first interface establishes a connection between the server and the communications units via a local network, the data being transmitted using an IP protocol.

8. A communications unit for a communications network having a server, wherein the server includes a first interface for connecting the server to the communications network and a first controller for centrally controlling network-wide performance features in the communications network, the communications unit comprising:
a second interface for connecting the communications unit to the communications network;
a second controller for controlling the performance features in the communications network using the server.

9. A communications unit for communications network as claimed in claim 8, wherein signaling messages are at least one of generated and evaluated by the second controller in order to control the performance features, the signaling messages being transmitted between the server and the communications unit.

10. A communications unit for a communications network as claimed in claim 9, wherein the second interface transmits the signaling messages between the communications unit and the server.

11. A communications unit for a communications network as claimed in claim 8, wherein the second interface establishes a connection between the server and the communications unit via a local network, the data being transmitted using an IP protocol.

12. A method for controlling performance features in a communications network, the method comprising the steps of:
providing a plurality of communications units which are networked to one another and connected to the communications network;
providing a server connected to the communications network; and
centrally controlling the performance features in the communications network via the server.

13. A method for controlling performance features in a communications network as claimed in claim 12, wherein signaling messages are transmitted between the server and at least one of the plurality of communications units in order to implement network-wide performance features.

14. A method for controlling performance features in a communications network as claimed in claim 12, wherein performance feature-specific data are stored centrally in the server and in the communications units.

15. A method for controlling performance features in a communications network as claimed in claim 12, wherein performance features which relate to an individual communications unit are centrally controlled.

16. A method for controlling performance features in a communications network as claimed in claim 12, wherein performance features which relate simultaneously to a plurality of communications units are centrally controlled.

17. A method for controlling performance features in a communications network as claimed in claim 12, wherein the communications network is a private communications network.
